(19) United States
(12) Patent Application Publication
(10) Pub. No.: US 2026/0257674 A1
(43) Pub. Date: Sep. 3, 2026

(54) VEHICLE CONTROL DEVICE, VEHICLE CONTROL METHOD, AND NON- TRANSITORY COMPUTER-READABLE STORAGE MEDIUM

(71) Applicant: HONDA MOTOR CO., LTD., Tokyo (JP)

(72) Inventor: Yoshiki ONO, Tokyo (JP)

(21) Appl. No.: 19/541,518

(22) Filed: Feb. 17, 2026

(30) Foreign Application Priority Data
Mar. 3, 2025 (JP) 2025-033253

(51) Int. Cl. B60W 30/09; B60W 30/12

(52) U.S. Cl. CPC B60W 30/09; B60W 30/12

(57) ABSTRACT

A vehicle control device includes: a sign recognizer configured to recognize, from an image captured by a camera configured to capture an image of an area around a vehicle, a sign part corresponding to a lane reduction sign including one or two bent line parts each including a bent portion and multiple straight line parts each of which is a straight solid line or broken line; and a merging lane identifier configured to acquire, from the sign part, one or two first shapes corresponding to the one or two bent line parts and multiple second shapes corresponding to the multiple straight line parts, and to identify position of a merging lane(s) based on the one or two first shapes and the multiple second shapes.

### TECHNICAL FIELD

The present invention relates to a vehicle control device, a vehicle control method, and a control program (stored in a non-transitory computer-readable storage medium).

### BACKGROUND ART

In recent years, efforts have been actively made to provide sustainable transport systems that take into account people in vulnerable situations among traffic participants. To achieve this, research and development related to driving assistance technology are being conducted to further improve safety and convenience of traffic.

JP2017-81276A discloses a vehicle control device including: an image pickup unit configured to acquire a vehicle front image; a merging lane identifier configured to detect a lane reduction sign in the vehicle front image and identify a merging lane based on the lane reduction sign; and a driving control unit which, in a case where the vehicle is on the merging lane, performs steering assist control toward another lane. The merging lane identifier performs pattern matching by referring to road sign templates and construction sign templates that are stored in a storage unit in advance, to thereby identify the number of lanes and the position of the merging lane indicated by the road sign or the construction sign. The templates for performing pattern matching are generated according to the lane reduction signs that may exist in Japan or in foreign countries.

However, as shown in FIG. 9, there are various lane reduction signs, and it is difficult to store all of them as the templates. Consequently, there is a risk that the identification accuracy of the merging lane may be lowered when encountering an unknown lane reduction sign. Also, depending on the angle of the lane reduction sign with respect to the camera, the appearance of the lane reduction sign in the image changes. Therefore, even if the lane reduction sign is known, there may be a case where the identification accuracy of the merging lane is lowered.

### SUMMARY OF THE INVENTION

In view of the foregoing background, an object of one aspect of the present invention is to provide a vehicle control device, a vehicle control method, and a control program (stored in a non-transitory computer-readable storage medium) capable of identifying a merging lane from a lane reduction sign with good accuracy.

To achieve the above object, one aspect of the present invention provides a vehicle control device, comprising: a sign recognizer configured to recognize, from an image captured by a camera configured to capture an image of an area around a vehicle, a sign part corresponding to a lane reduction sign including one or two bent line parts each including a bent portion and multiple straight line parts each of which is a straight solid line or broken line; and a merging lane identifier configured to acquire, from the sign part, one or two first shapes corresponding to the one or two bent line parts and multiple second shapes corresponding to the multiple straight line parts, and to identify position of a merging lane(s) based on the one or two first shapes and the multiple second shapes.

Another aspect of the present invention provides a vehicle control method to be executed by a computer, the vehicle control method comprising: recognizing, from an image captured by a camera configured to capture an image of an area around a vehicle, a sign part corresponding to a lane reduction sign including one or two bent line parts each including a bent portion and multiple straight line parts each of which is a straight solid line or broken line; and acquiring, from the sign part, one or two first shapes corresponding to the one or two bent line parts and multiple second shapes corresponding to the multiple straight line parts and identifying position of a merging lane(s) based on the one or two first shapes and the multiple second shapes.

Another aspect of the present invention provides a non-transitory computer-readable storage medium storing a control program, wherein the control program, when executed by a computer, causes the computer to execute a vehicle control method comprising: recognizing, from an image captured by a camera configured to capture an image of an area around a vehicle, a sign part corresponding to a lane reduction sign including one or two bent line parts each including a bent portion and multiple straight line parts each of which is a straight solid line or broken line; and acquiring, from the sign part, one or two first shapes corresponding to the one or two bent line parts and multiple second shapes corresponding to the multiple straight line parts and identifying position of a merging lane(s) based on the one or two first shapes and the multiple second shapes.

According to the above aspects, a vehicle control device, a vehicle control method, and a control program capable of identifying a merging lane from a lane reduction sign with good accuracy can be provided.

### BRIEF DESCRIPTION OF THE DRAWINGS

FIG. 1 is a configuration diagram of a vehicle control device according to an embodiment;

FIG. 2 is an explanatory diagram showing an example of a lane reduction sign;

FIG. 3 is a configuration diagram of a sign analyzer;

FIG. 4 is an explanatory diagram showing regions identified by a region discriminator from a sign part;

FIG. 5 is an explanatory diagram showing bounding boxes identified by a rectangle discriminator from the sign part;

FIG. 6 is a flowchart of the merging lane identifying process;

FIG. 7 is a flowchart of the first identifying process;

FIG. 8 is a flowchart of the second identifying process; and

FIG. 9 shows exemplary photographs of various lane reduction signs.

### DETAILED DESCRIPTION OF THE INVENTION

In the following, an embodiment of a vehicle control device, a vehicle control method, and a control program will be described with reference to the drawings.

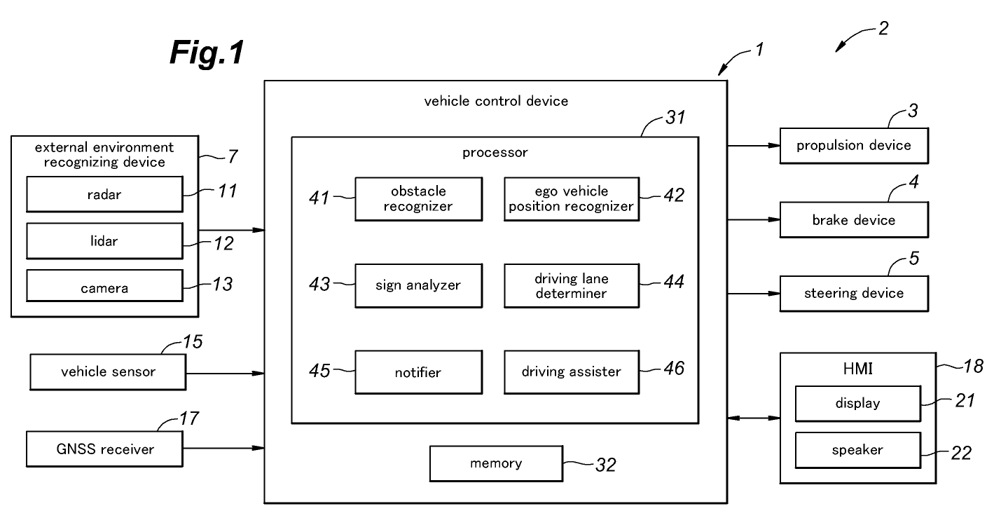

FIG. 1 shows a configuration of a vehicle control device 1. The vehicle control device 1 is provided in a vehicle 2. The vehicle 2 is a four-wheeled automobile. The vehicle 2 may be an autonomous vehicle or a vehicle with a driving assistance function.

The vehicle 2 includes a propulsion device 3, a brake device 4, and a steering device 5. The propulsion device 3 is a device that provides the driving force to the vehicle 2, and includes, for example, a power source and a transmission. The power source includes at least one of an internal combustion engine such as a gasoline engine or a diesel engine, and an electric motor. The brake device 4 is a device that applies the braking force to the vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the vehicle control device 1.

The vehicle 2 includes an external environment recognizing device 7. The external environment recognizing device 7 is a device for detecting objects outside the vehicle 2 and the like. The external environment recognizing device 7 is a sensor that captures electromagnetic waves and light from the surroundings of the vehicle 2 to detect the objects outside the vehicle 2. The external environment recognizing device 7 includes a radar 11, a lidar 12 (LIDAR), and a camera 13.

The radar 11 transmits a radio wave to around the vehicle 2 and receives the radio wave reflected by an object, thereby detecting the position and the velocity of the object. The lidar 12 emits light such as infrared light to around the vehicle 2 and captures the light reflected by an object, thereby detecting the position (distance and direction) of the object. The lidar 12 preferably detects an obstacle present in an area in front of the vehicle 2.

The camera 13 captures images of the surroundings of the vehicle 2 to acquire images around the vehicle 2. The images around the vehicle 2 may include surrounding vehicles, pedestrians, guardrails, curbs, walls, a median strip, roads, lane markings, road signs, signboards, road markings on the roads, and so on that are present around the vehicle 2. The camera 13 may be a digital camera using a solid imaging element such as a CCD or a CMOS, for example. The camera 13 includes at least a front camera for capturing an image of an area in front of the vehicle 2. The camera 13 may further include a rear camera for capturing an image to the rear of the vehicle 2 and a pair of side cameras for capturing images to the left and right of the vehicle 2. The camera 13 may be a stereo camera, for example.

The vehicle 2 includes a vehicle sensor 15. The vehicle sensor 15 includes a vehicle speed sensor that detects the speed of the vehicle 2, an acceleration sensor that detects the acceleration thereof, a yaw rate sensor that detects the angular velocity around the vertical axis, and the like. The vehicle sensor 15 may include an azimuth sensor that detects the orientation of the vehicle 2, and the like.

The vehicle 2 includes a global navigation satellite system (GNSS) receiver 17. The GNSS receiver 17 identifies the position (latitude and longitude) of the vehicle 2 based on the signal received from artificial satellites (positioning satellites).

The vehicle 2 includes a human machine interface (HMI) 18. The HMI 18 notifies the occupant of various kinds of information by display and/or audio and receives input operations performed by the occupant. The HMI 18 includes a display 21 and a speaker 22. The display 21 is preferably a touch panel display.

The vehicle control device 1 is a computer including a processor 31 and a memory 32 communicatively connected to the processor 31. The processor 31 may include at least one of the following cores: a central processing unit (CPU), a graphics processing unit (GPU), and a reduced instruction set computer (RISC). The memory 32 stores the control program executed by the processor 31 and various data. The memory 32 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle control device 1 may be realized by hardware such as a large scale integration (LSI), an application specific integrated circuit (ASIC), or a field-programmable gate array (FPGA), or may be realized by a combination of software and hardware. The vehicle control device 1 may be composed of a single piece of hardware, or may be composed of plural pieces of hardware capable of communicating with each other. A portion of the vehicle control device 1 may be composed of an external server provided outside the vehicle 2.

The processor 31 realizes various applications by executing the program stored in the memory 32. The program may be stored in a removable recordable medium such as a DVD or a CD-ROM, and installed in the memory 32 as the recordable medium is read by a reading device. The program may also be downloaded and installed in the memory 32 via a communication network such as the Internet.

The memory 32 preferably stores map information. The map information is preferably high accuracy map information. The map information includes road information which includes types of roads such as expressways, toll roads, national highways, and prefectural roads, the number of lanes of each road, the center position (three-dimensional coordinate including a longitude, a latitude, and a height) of each lane, shapes of road markings such as road delimiting lines and lane boundaries, presence or absence sidewalks, curbs, fences, etc., intersection positions, positions of merging and branching points of each lane, positions of emergency parking zones, the width of each lane, signs provided on the roads, and so on. Also, the map information may include traffic regulation information, address information (address and post code), facility information, telephone number information, and so on.

By executing the program stored in the memory 32, the processor 31 functions as an obstacle recognizer 41, an ego vehicle position recognizer 42, a sign analyzer 43, a driving lane determiner 44, a notifier 45, and a driving assister 46.

The obstacle recognizer 41 recognizes the surrounding environment of the vehicle 2. The obstacle recognizer 41 recognizes the surrounding environment (external environment), including obstacles located around the vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The obstacle recognizer 41 can acquire the position, speed, acceleration, and other states of the surrounding vehicles from the detection results of the external environment recognizing device 7.

The ego vehicle position recognizer 42 recognizes the position of the vehicle 2. The ego vehicle position recognizer 42 preferably recognize the position of the vehicle 2 based on the GNSS signal received by the GNSS receiver 17.

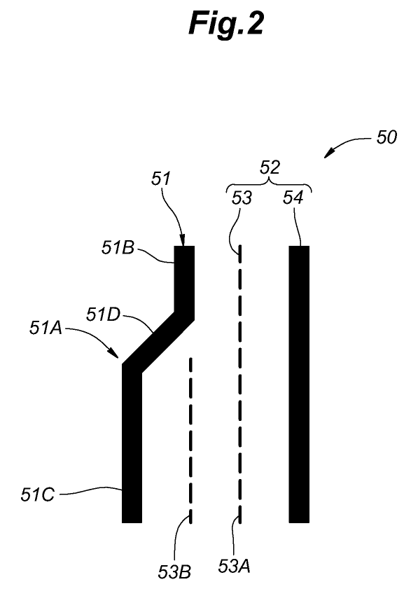

The sign analyzer 43 recognizes a lane reduction sign 50 and identifies the position of the merging lane(s) from the lane reduction sign 50. FIG. 2 shows a representative example of the lane reduction sign 50. The lane reduction sign 50 may be drawn alone on a display board or a signboard or may be drawn on a display board or a signboard together with other letters and figures.

As shown in FIG. 2, the lane reduction sign 50 includes one or two bent line parts 51 each including a bent portion 51A and multiple straight line parts 52 each of which may be a straight solid line or broken line. Each bent line part 51 includes an upper portion 51B and a lower portion 51C each extending straight in the up-down direction and a straight intermediate portion 51D which is connected to the upper end of the lower portion 51C and the lower end of the upper portion 51B and extends obliquely with respect to the up-down direction. The intermediate portion 51D constitutes the bent portion 51A. The upper portion 51B is offset leftward or rightward relative to the lower portion 51C. The straight line parts 52 include at least one broken line part 53 and zero or one solid line part 54. Each of the broken line part(s) 53 and the solid line part 54 extends in the up-down direction. The lower portion 51C of the bent line part 51, the broken line part(s) 53, and the solid line part 54 extend in parallel with other and spaced from each other in the left-right direction. Note that in the case where the sign indicates a decrease or increase of the width instead of a decrease of the number of lanes, the broken line part(s) 53 may not be included.

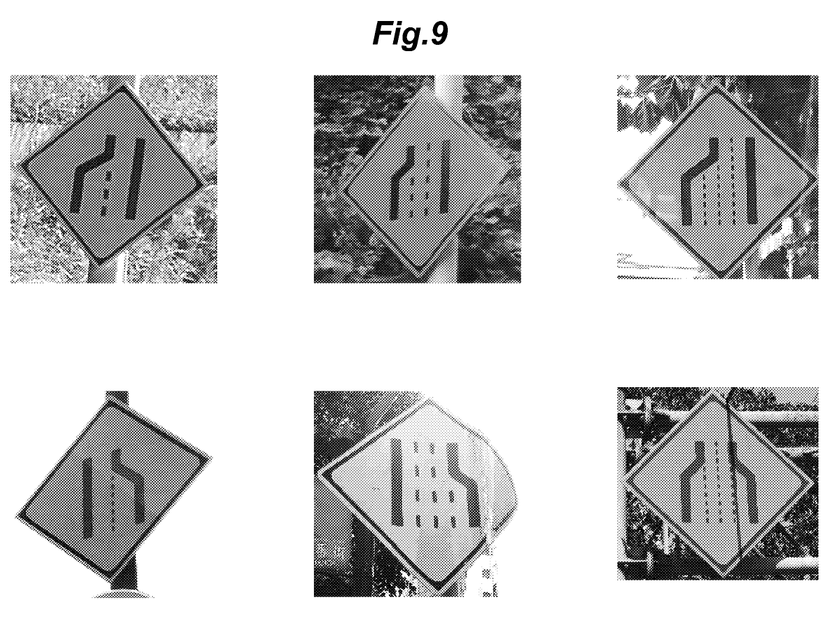

At the left end and the right end of the lane reduction sign 50, the bent line part 51 or the solid line part 54 is located. If the solid line part 54 is located at one of the left end and the right end of the lane reduction sign 50, the bent line part 51 is located at the other of the left end and the right end. In some cases, the bent line part 51 is located at both the left end and the right end of the lane reduction sign 50 (see FIG. 9).

The at least one broken line part 53 is located between the bent line part 51 and the solid line part 54 (or the bent line part 51) located at the left end and the right end of the lane reduction sign 50. In the illustrated example, the at least one broken line part 53 includes a long broken line 53A and a short broken line 53B having a vertical length less than or equal to a predetermined percentage (which is less than 100 %) of the vertical length of the long broken line 53A. The predetermined percentage is 70 %, for example. The lane reduction sign 50 includes at least one short broken line 53B. The lane reduction sign 50 may or may not include the long broken line 53A.

The regions between the bent line part 51, the broken line part(s) 53, and the solid line part 54 each represent a lane. The lateral widths of the regions between the bent line part 51, the broken line part(s) 53, and the solid line part 54 are set to be substantially the same. A value obtained by adding one to the total number of the broken line parts 53 becomes the number of lanes. Also, a value obtained by subtracting one from the total number of the bent line part 51, the broken line part(s) 53, and the solid line part 54 also indicates the number of lanes. The lanes include a merging lane(s) and a remaining lane(s) (continuing lane(s)). A merging lane has and end within a predetermined range in front. On the other hand, a remaining lane does not have an end within the predetermined range in front. The bent line part 51 or each short broken line 53B represents a position where the merging lane exists. The number of the short broken line(s) 53B represents the number of the merging lane(s). The region located below the intermediate portion 51D of the bent line part 51 represents the merging lane(s). The number of the short broken line(s) 53B located below the intermediate portion 51D and the upper portion 51B of the bent line part 51 located at the left end or the right end of the lane reduction sign 50 represents the number of the merging lane(s) on the left side or the right side. For example, in the case where there are two regions separated by a short broken line 53B below the intermediate portion 51D of the bent line part 51, there are two merging lanes. The vertical length of the region representing the merging lane is shorter than the vertical length of the region representing the remaining lane.

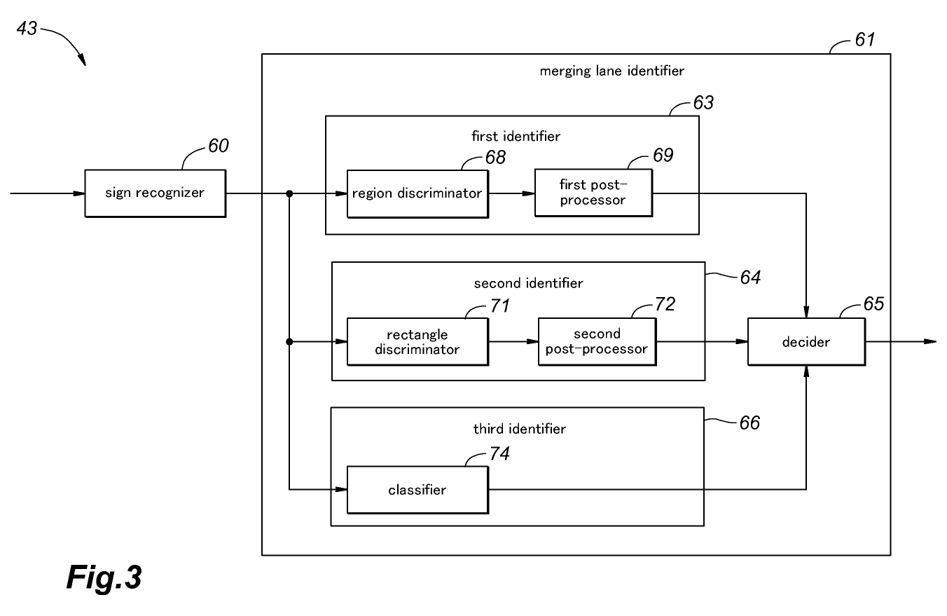

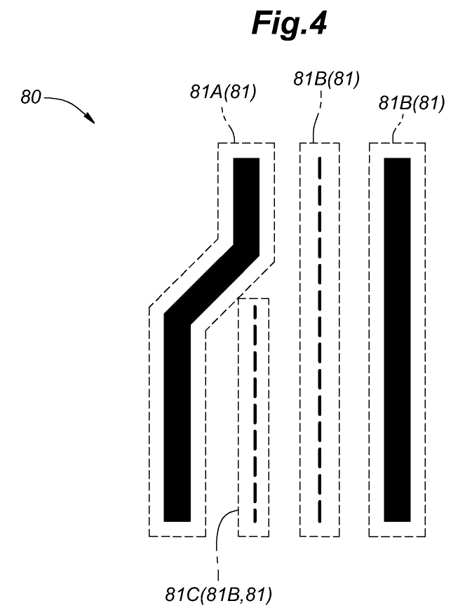

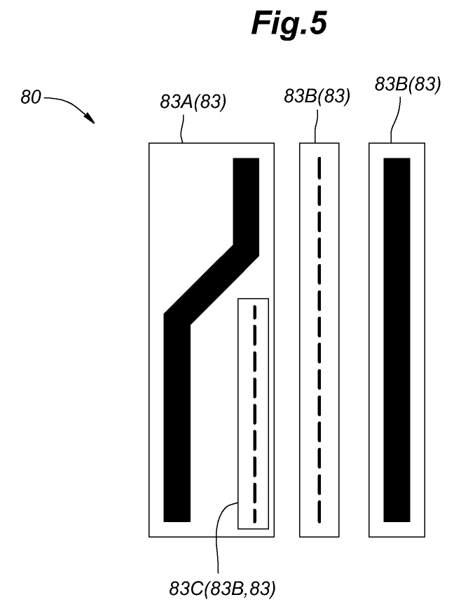

As shown in FIG. 3, the sign analyzer 43 includes a sign recognizer 60 and a merging lane identifier 61. The sign recognizer 60 recognizes a sign part 80 corresponding to the lane reduction sign 50 from the image captured by the camera 13 configured to capture an image of an area around the vehicle 2. As shown in FIGS. 4 and 5, the sign recognizer 60 preferably recognizes the sign part 80 corresponding to the lane reduction sign 50 from the image by using known various image recognition technologies. For example, preferably, the sign recognizer 60 recognizes the sign part 80 corresponding to the lane reduction sign 50 by using a trained model that outputs the sign part 80 corresponding to the lane reduction sign 50 in response to the inputted image. For example, the trained model is preferably composed of a convolutional neural network (CNN). Also, the sign recognizer 60 may recognize the sign part 80 corresponding to the lane reduction sign 50 by performing image pattern matching by using dictionary information containing various lane reduction signs 50.

As shown in FIGS. 4 and 5, the merging lane identifier 61 acquires, from the sign part 80, one or two first shapes 81A, 83A corresponding to the one or two bent line parts 51 and multiple second shapes 81B, 83B corresponding to the multiple straight line parts 52, and identifies the position of the merging lane(s) based on the one or two first shapes 81A, 83A and the multiple second shapes 81B, 83B. As shown in FIG. 3, the merging lane identifier 61 includes at least one of a first identifier 63 and a second identifier 64 and a decider 65 that identifies the merging lane(s) based on at least one of the identification result of the first identifier 63 and the identification result of the second identifier 64. In the present embodiment, the merging lane identifier 61 includes the first identifier 63 and the second identifier 64. Also, the merging lane identifier 61 includes a third identifier 66.

The first identifier 63 includes a region discriminator 68 and a first post-processor 69. The first identifier 63 identifies the position of the merging lane(s) by executing a first identifying process (method). As shown in FIG. 4, the region discriminator 68 acquires, from the sign part 80, multiple regions 81 corresponding to the one or two bent line parts 51 and the multiple straight line parts 52. The region discriminator 68 performs clustering on the sign part 80 acquired by the sign recognizer 60 and recognizes, from the sign part 80, the regions 81 respectively corresponding to the bent line part(s) 51 and the straight line parts 52. The clustering method used here is preferably DBSCAN (Density-Based Spatial Clustering of Applications with Noise), for example. The region discriminator 68 is preferably adjusted to recognize each broken line part 53 extending in a straight line as one region 81. The region discriminator 68 identifies the coordinates of each region 81 to identify the position and shape of each region 81.

The first post-processor 69 classifies the multiple regions 81 acquired by the region discriminator 68 as the one or two first shapes 81A corresponding to the one or two bent line parts 51 and the multiple second shapes 81B corresponding to the multiple straight line parts 52. The first shape(s) 81A and the second shapes 81B are preferably classified based on the lateral widths, namely, the lengths in the left-right direction, of the regions 81. The lateral width of each region 81 is preferably acquired based on the coordinates of the left end and the right end of each region 81. The first shape(s) 81A corresponding to the one or two bent line parts 51 has a lateral width larger than the lateral width of each of the second shapes 81B corresponding to the straight line parts 52. For example, the first post-processor 69 divides the regions 81 into a first group with relatively large lateral widths and a second group with relatively small lateral widths, and classifies each of the regions 81 included in the first group as the first shape 81A and each of the regions 81 included in the second group as the second shape 81B.

The first post-processor 69 determines that the leftmost lane is the merging lane in the case where there is one first shape 81A and the first shape 81A is located at the left end. Also, the first post-processor 69 determines that the rightmost lane is the merging lane in the case where there is one first shape 81A and the first shape 81A is located at the right end. The first post-processor 69 determines that the leftmost lane and the rightmost lane are the merging lanes in the case where there are two first shapes 81A.

The first post-processor 69 classifies each second shape 81B, of the multiple second shapes 81B, that has a vertical length less than or equal to a predetermined percentage of the vertical length of the first shape(s) 81A as a short second shape 81C. The predetermined percentage is preferably 70%, for example. The first post-processor 69 identifies the number of merging lane(s) based on the number of the short second shape(s) 81C present within the lateral width of the first shape(s) 81A. The number of merging lane(s) is the number of the short second shape(s) 81C present within the lateral width of the first shape(s) 81A. For example, in the case where the first shape 81A is located at the left end and two short second shapes 81C are located within the lateral width of the first shape 81A, the first post-processor 69 determines that the first and second lanes from the left are merging lanes. For example, in the case where the first shape 81A is located at the right end and one short second shape 81C is located within the lateral width of the first shape 81A, the first post-processor 69 determines that the first lane from the right is a merging lane.

The first post-processor 69 performs calculation of subtracting one from the total number of the first shape(s) 81A and the second shapes 81B, and acquires the calculated value as the number of lanes prior to lane reduction. The first post-processor 69 may identify the remaining lane(s) by excluding the merging lane(s) from the lanes prior to lane reduction.

As shown in FIG. 3, the first post-processor 69 outputs the identification result including the position of the merging lane(s) to the decider 65. The data outputted from the first post-processor 69 to the decider 65 preferably includes, for example, the lane numbers assigned to the respective lanes prior to lane reduction in the ascending order from the left and the flags indicating whether the lanes corresponding to the respective lane numbers are merging lanes.

The second identifier 64 includes a rectangle discriminator 71 and a second post-processor 72. The second identifier 64 identifies the position of the merging lane(s) by executing a second identifying process (method). As shown in FIG. 5, the rectangle discriminator 71 acquires, from the sign part 80, multiple bounding boxes 83 respectively surrounding the one or two bent line parts 51 and the multiple straight line parts 52. The rectangle discriminator 71 is preferably composed of a trained model using an R-CNN (Region-Convolutional Neural Networks), a Fast R-CNN, a Faster R-CNN, a YOLO, an SSD (Single Shot Detector), or the like. Each bounding box 83 is a rectangle extending in the left-right direction and the up-down direction. Each bounding box 83 is preferably represented by the coordinates of the two corners thereof that are positioned diagonally or the coordinate of the center point, the width, and the height thereof, for example. The rectangle discriminator 71 is preferably adjusted to set one bounding box 83 for each broken line part 53 extending in a straight line.

The second post-processor 72 classifies the multiple bounding boxes 83 acquired by the rectangle discriminator 71 as the one or two first shapes 83A corresponding to the one or two bent line parts 51 and the multiple second shapes 83B corresponding to the multiple straight line parts 52. The first shape(s) 83A and the second shapes 83B are preferably classified based on the lateral widths of the bounding boxes 83. The first shape(s) 83A corresponding to the bent line part(s) 51 has a lateral width larger than the lateral width of each of the second shapes 83B corresponding to the straight line parts 52. For example, the second post-processor 72 divides the bounding boxes 83 into a first group with relatively large lateral widths and a second group with relatively small lateral widths, and classifies each of the bounding boxes 83 included in the first group as the first shape 83A and each of the bounding boxes 83 included in the second group as the second shape 83B.

The second post-processor 72 determines that the leftmost lane is the merging lane in the case where there is one first shape 83A and the first shape 83A is located at the left end. Also, the second post-processor 72 determines that the rightmost lane is the merging lane in the case where there is one first shape 83A and the first shape 83A is located at the right end. The second post-processor 72 determines that the leftmost lane and the rightmost lane are the merging lanes in the case where there are two first shapes 83A.

The second post-processor 72 classifies each second shape 83B, of the multiple second shapes 83B, that has a vertical length less than or equal to a predetermined percentage of the vertical length of the first shape(s) 83A as the short second shape 83C. The predetermined percentage is preferably 70 %, for example. The second post-processor 72 identifies the number of merging lane(s) based on the short second shape(s) 83C present within the lateral width of the first shape(s) 83A. The number of merging lane(s) is the number of the short second shape(s) 83C present within the lateral width of the first shape 83A. For example, in the case where the first shape 83A is located at the left end and two short second shapes 83C are located within the lateral width of the first shape 83A, the second post-processor 72 determines that the first and second lanes from the left are merging lanes. For example, in the case where the first shape 83A is located at the right end and one short second shape 83C is located within the lateral width of the first shape 83A, the second post-processor 72 determines that the first lane from the right is a merging lane.

The second post-processor 72 performs calculation of subtracting one from the total number of the first shape(s) 83A and the second shapes 83B, and acquires the calculated value as the number of lanes prior to lane reduction. The second post-processor 72 may identify the remaining lane(s) by excluding the merging lane(s) from the lanes prior to lane reduction.

The second post-processor 72 outputs the identification result including the position of the merging lane(s) to the decider 65. The data outputted from the second post-processor 72 to the decider 65 preferably includes, for example, lane numbers assigned to the respective lanes prior to lane reduction in the ascending order from the left and flags indicating whether the lanes corresponding to the respective lane numbers are merging lanes.

As shown in FIG. 3, the third identifier 66 includes a classifier 74 and uses the classifier 74 to identify the position of the merging lane(s) in response to the input of the sign part 80. The third identifier 66 executes a third identifying process using the classifier 74. The classifier 74 outputs the position of the merging lane(s) in response to the input of the sign part 80. The classifier 74 is preferably a trained model that outputs the position of the merging lane(s) in response to the input of the sign part 80. The trained model is preferably composed of a convolutional neural network. The trained model is preferably trained based on training data in which images of lane reduction signs 50 are associated with the number of lanes prior to lane reduction and the position of the merging lane(s). The third identifier 66 outputs, in response to the input of the sign part 80 in the image, an identification result including the position of the merging lane(s) to the decider 65. The data outputted from the third identifier 66 to the decider 65 preferably includes, for example, the lane numbers assigned to the respective lanes prior to lane reduction in the ascending order from the left and the flags indicating whether the lanes corresponding to the respective lane numbers are merging lanes.

The decider 65 identifies the position of the merging lane(s) based on the identification result of the first identifier 63, the identification result of the second identifier 64, and the identification result of the third identifier 66. The decider 65 may perform a majority voting process on the identification result of the first identifier 63, the identification result of the second identifier 64, and the identification result of the third identifier 66 and identify the position of the merging lane(s) based on the identification result that appears most frequently. Also, the majority voting process may be performed for each lane of each identification result. Further, the decider 65 may set a priority order on the identification result of the first identifier 63, the identification result of the second identifier 64, and the identification result of the third identifier 66 in advance and identify the position of the merging lane(s) based on the identification result with the highest priority order. The decider 65 outputs the merging lane information related to the merging lane(s) to the driving lane determiner 44. The merging lane information outputted from the decider 65 may be also referred to as the output of the merging lane identifier 61. The merging lane information preferably includes, for example, the lane numbers assigned to the respective lanes prior to lane reduction in the ascending order from the left and the flags indicating whether the lanes corresponding to the respective lane numbers are merging lanes.

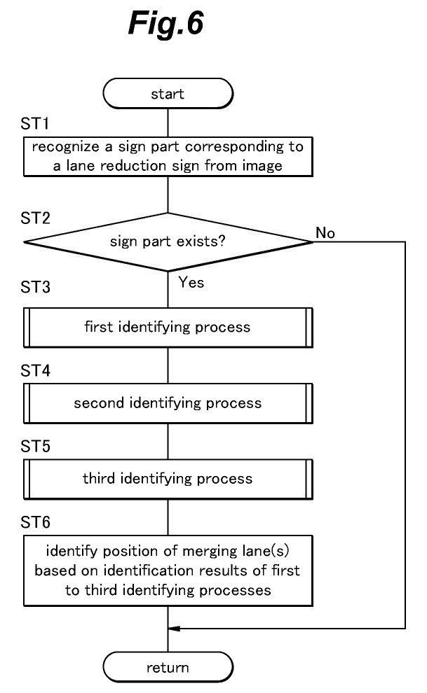

Next, with reference to FIG. 6 to FIG. 8, a control flow of the merging lane identifying process executed by the sign analyzer 43 will be described. The sign analyzer 43 repeatedly executes the merging lane identifying process at a predetermined time interval. First, the sign recognizer 60 of the sign analyzer 43 recognizes, from the image of an area in front of the vehicle 2 acquired by the camera 13, the sign part 80 corresponding to the lane reduction sign 50 (ST1).

Next, the sign analyzer 43 determines whether the sign part 80 corresponding to the lane reduction sign 50 exists in the image (ST2). In the case where the sign part 80 corresponding to the lane reduction sign 50 does not exist in the image (ST2: No), the sign analyzer 43 ends the merging lane identifying process.

In the case where the sign part 80 corresponding to the lane reduction sign 50 exists in the image (ST2: Yes), the first identifier 63 executes the first identifying process using the region discriminator 68 (ST3).

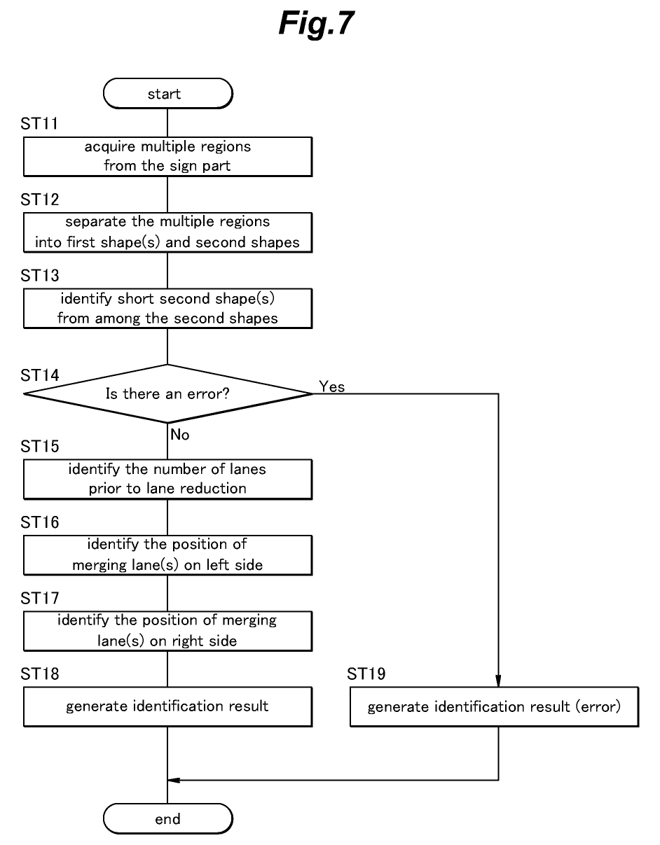

The first identifying process is executed according to a flowchart in FIG. 7. In the first identifying process, first, the region discriminator 68 acquires, from the sign part 80 in the image, multiple regions 81 corresponding to the bent line part(s) 51 and the straight line parts 52 (ST11). Subsequently, the first post-processor 69 separates the multiple regions 81 into the first shape(s) 81A and the second shapes 81B (ST12). Subsequently, the first post-processor 69 identifies the short second shape(s) 81C from among the multiple second shapes 81B (ST13).

Next, the first post-processor 69 determines whether there is an error in the identification of the first shape(s) 81A, the second shapes 81B, and the short second shape(s) 81C (ST14). The first post-processor 69 preferably determines that there is an error when, for example, any of the following conditions is met: (1) the number of the first shape(s) 81A is 0 or 3 or more, (2) the total number of the first shape(s) 81A and the second shapes 81B is less than or equal to 2, and (3) the number of the short second shape(s) 81C is 0.

In the case where there is no error in the identification of the first shape(s) 81A, the second shapes 81B, and the short second shape(s) 81C (ST14: No), the first post-processor 69 sets a number obtained by subtracting 1 from the number of the regions 81 as the number of lanes prior to lane reduction (ST15).

Next, the first post-processor 69 identifies the number of the merging lane(s) on the left side (ST16). At this time, the first post-processor 69 determines whether the first shape 81A exists at the left end of the multiple regions 81. In the case where the first shape 81A does not exist at the left end of the multiple regions 81, the first post-processor 69 determines that the number of the merging lane(s) on the left side is 0. In the case where the first shape 81A exists at the left end of the multiple regions 81, the first post-processor 69 counts the number of the short second shape(s) 81C present within the lateral width of the first shape 81A that exists at the left end, and sets the number as the number of the merging lane(s) on the left side.

Next, the first post-processor 69 identifies the number of the merging lane(s) on the right side (ST17). At this time, the first post-processor 69 determines whether the first shape 81A exists at the right end of the multiple regions 81. In the case where the first shape 81A does not exist at the right end of the multiple regions 81, the first post-processor 69 determines that the number of the merging lane(s) on the right side is 0. In the case where the first shape 81A exists at the right end of the multiple regions 81, the first post-processor 69 counts the number of the short second shape(s) 81C present within the lateral width of the first shape 81A that exists at the right end, and sets the number as the number of the merging lane(s) on the right side.

Next, the first post-processor 69 generates an identification result based on the results of step ST16 and step ST17 (ST18). The identification result preferably includes the lane numbers assigned to the respective lanes prior to lane reduction in the ascending order from the left and the flags indicating whether the lanes corresponding to the respective lane numbers are merging lanes.

In the case where there is an error in the identification of the first shape(s) 81A, the second shapes 81B, and the short second shape(s) 81C (ST14: Yes), the first post-processor 69 generates an identification result indicating that the merging lane(s) cannot be identified (ST19). After the identification result is generated in step ST18 or ST19, the first identifying process ends.

After the first identifying process has been executed, the second identifier 64 executes the second identifying process using the rectangle discriminator 71 (ST4).

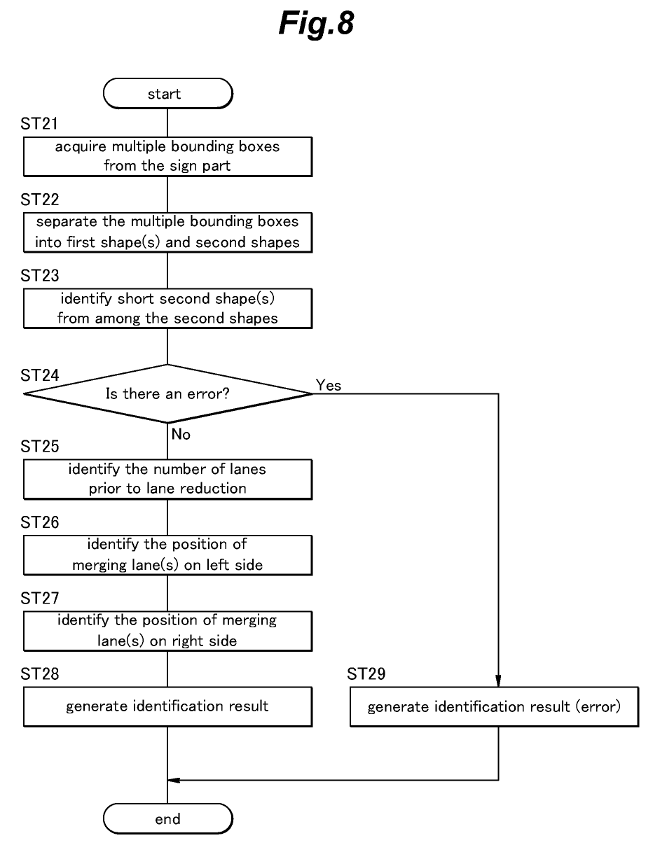

The second identifying process is executed according to a flowchart in FIG. 8. In the second identifying process, first, the rectangle discriminator 71 acquires, from the sign part 80 in the image, multiple bounding boxes 83 corresponding to the bent line part(s) 51 and the straight line parts 52 (ST21). Subsequently, the second post-processor 72 separates the multiple bounding boxes 83 into the first shape(s) 83A and the second shapes 83B (ST22). Subsequently, the second post-processor 72 identifies the short second shape(s) 83C from among the multiple second shapes 83B (ST23).

Next, the second post-processor 72 determines whether there is an error in the identification of the first shape(s) 83A, the second shapes 83B, and the short second shape(s) 83C (ST24). The second post-processor 72 preferably determines that there is an error when, for example, any of the following conditions is met: (1) the number of the first shape(s) 83A is 0 or 3 or more, (2) the total number of the first shape(s) 83A and the second shapes 83B is less than or equal to 2, and (3) the number of the short second shape(s) 83C is 0.

In the case where there is no error in the identification of the first shape(s) 83A, the second shapes 83B, and the short second shape(s) 83C (ST24: No), the second post-processor 72 sets a number obtained by subtracting 1 from the number of the bounding boxes 83 as the number of lanes prior to lane reduction (ST25).

Next, the second post-processor 72 identifies the number of the merging lane(s) on the left side (ST26). At this time, the second post-processor 72 determines whether the first shape 83A exists at the left end of the multiple bounding boxes 83. In the case where the first shape 83A does not exist at the left end of the multiple bounding boxes 83, the second post-processor 72 determines that the number of the merging lane(s) on the left side is 0. In the case where the first shape 83A exists at the left end of the multiple bounding boxes 83, the second post-processor 72 counts the number of the short second shape(s) 83C present within the lateral width of the first shape 83A that exists at the left end, and sets the number as the number of the merging lane(s) on the left side.

Next, the second post-processor 72 identifies the number of the merging lane(s) on the right side (ST27). At this time, the second post-processor 72 determines whether the first shape 83A exists at the right end of the multiple bounding boxes 83. In the case where the first shape 83A does not exist at the right end of the multiple bounding boxes 83, the second post-processor 72 determines that the number of the merging lane(s) on the right side is 0. In the case where the first shape 83A exists at the right end of the multiple bounding boxes 83, the second post-processor 72 counts the number of the short second shape(s) 83C present within the lateral width of the first shape 83A that exists at the right end, and sets the number as the number of the merging lane(s) on the right side.

Next, the second post-processor 72 generates an identification result based on the results of step ST26 and step ST27 (ST28). The identification result preferably includes the lane numbers assigned to the respective lanes prior to lane reduction in the ascending order from the left and the flags indicating whether the lanes corresponding to the respective lane numbers are merging lanes.

In the case where there is an error in the identification of the first shape(s) 83A, the second shapes 83B, and the short second shape(s) 83C (ST24: Yes), the second post-processor 72 generates an identification result indicating that the merging lane(s) cannot be identified (ST29). After the identification result is generated in step ST28 or ST29, the second identifying process ends.

After the second identifying process has been executed, the third identifier 66 executes the third identifying process using the classifier 74 (ST5). In the third identifying process, the classifier 74 outputs an identification result including the position of the merging lane(s) in response to the input of the sign part 80 in the image.

After the third identifying process has been executed, the decider 65 identifies the position of the merging lane(s) based on the identification result of the first identifier 63, the identification result of the second identifier 64, and the identification result of the third identifier 66 (ST6).

The driving lane determiner 44 determines whether the lane on which the vehicle 2 is traveling is a merging lane based on the merging lane information from the merging lane identifier 61 and the position of the vehicle 2. The driving lane determiner 44 identifies the lane on which the vehicle 2 is traveling based on the position of the vehicle 2 acquired by the ego vehicle position recognizer 42 and the map information. The driving lane determiner 44 determines whether the lane on which the vehicle 2 is traveling is a merging lane by comparing the position of the lane on which the vehicle 2 is traveling with the position of the merging lane(s) included in the merging lane information.

In the case where the driving lane determiner 44 determines that the lane on which the vehicle 2 is traveling is a merging lane, the notifier 45 controls at least one of the display 21 and the speaker 22 as a notification device to notify the occupant. The notifier 45 preferably controls the display 21 to make the display 21 display sentences and/or figures for prompting a lane change. Also, preferably, the notifier 45 controls the speaker 22 to make the speaker 22 output a voice and/or sound effects for prompting a lane change.

In the case where the driving lane determiner 44 determines that the lane on which the vehicle 2 is traveling is a merging lane, the driving assister 46 controls the steering device 5 to make the vehicle 2 change lanes to a remaining lane which is different from the merging lane. The driving assister 46 identifies the remaining lane(s) based on the merging lane information. Then, the driving assister 46 sets a target trajectory for making the vehicle 2 change lanes to the remaining lane. At this time, the driving assister 46 preferably sets the target trajectory so that the time to collision (TTC) with an obstacle recognized by the obstacle recognizer 41 is longer than or equal to a predetermined value. Then, the driving assister 46 preferably controls the steering device 5 such that the position of the vehicle 2 follows the target trajectory. In another embodiment, the driving assister 46 may perform control to provide an assist force to the steering wheel for operating the steering device 5 such that the position of the vehicle 2 follows the target trajectory.

According to the foregoing embodiment, the vehicle control device 1 capable of identifying the position of the merging lane(s) from the lane reduction sign 50 with good accuracy is provided. Since the vehicle control device 1 identifies the position of the merging lane(s) based on characteristic parts of the lane reduction sign 50, it is possible to properly identify the position of the merging lane(s) from various variations of the lane reduction sign 50.

Since the first identifying process executed by the first identifier 63 and the second identifying process executed by the second identifier 64 identify the position of the merging lane(s) based on characteristic parts of the lane reduction sign 50, they can identify the position of the merging lane(s) with good accuracy even if the lane reduction sign 50 has not been learned. Specifically, since the first identifier 63 and the second identifier 64 identify the position of the merging lane(s) based on the positional relationship between the bent line part(s) 51 and the straight line parts 52 which are elements of the lane reduction sign 50, it is possible to cope with various lane reduction signs 50 having varying number of bent line part(s) 51 and the straight line parts 52. Further, the vehicle control device 1 can improve the identification accuracy of the position of the merging lane(s) by taking into account the identification result of the third identifier 66 including the classifier 74.

When the vehicle 2 is positioned on a merging lane, the vehicle control device 1 can alert the occupant by controlling at least one of the display 21 and the speaker 22. Also, when the vehicle 2 is positioned on a merging lane, the vehicle control device 1 can make the vehicle 2 automatically change lanes by controlling the steering device 5.

The embodiment may be modified in various ways without being limited to the above-described configuration. For example, some of the first identifier 63, the second identifier 64, the third identifier 66, and the decider 65 of the merging lane identifier 61 may be omitted. For example, the merging lane identifier 61 may be composed of the first identifier 63 or the second identifier 64. Also, the merging lane identifier 61 may be composed of the first identifier 63, the second identifier 64, and the decider 65. Also, the merging lane identifier 61 may be composed of the first identifier 63, the third identifier 66, and the decider 65. Also, the merging lane identifier 61 may be composed of the second identifier 64, the third identifier 66, and the decider 65.

The first post-processor 69 does not have to discriminate the short second shape(s) 81C from the second shapes 81B. In this case, it is preferable if the first post-processor 69 identifies the number of merging lane(s) based on the number of second shape(s) 81B present within the lateral width of the first shape 81A. Similarly, the second post-processor 72 does not have to discriminate the short second shape(s) 83C from the second shapes 83B. In this case, it is preferable if the second post-processor 72 identifies the number of merging lane(s) based on the number of second shape(s) 83B present within the lateral width of the first shape 83A.

The merging lane identifier 61 may identify the merging lane(s) at a predetermined time interval and correct the current identification result based on the previous identification result. Thereby, the identification accuracy of the position of the merging lane(s) can be improved. Since the image of the lane reduction sign 50 is acquired during travel of the vehicle 2, in some cases the acquired image of the lane reduction sign 50 may include a missing or unclear part. Therefore, by the merging lane identifier 61 performing identification of the merging lane(s) multiple times at a predetermined time interval, it is possible to improve the identification accuracy of the position of the merging lane(s).

The merging lane identifier 61 may identify a decrease or increase of the width based on the first shape(s) 81A, 83A and the second shapes 81B, 83B. For example, the merging lane identifier 61 may determine that the sign represents a decrease or increase of the width when the sign does not include the short broken line 53B. Also, the merging lane identifier 61 may identify a decrease or increase of the width based on the shape of each first shape 81A, 83A. For example, the merging lane identifier 61 may identify a decrease or increase of the width based on the lateral positions of the upper end and the lower end of each first shape 81A, 83A.

The above embodiment may be described as follows.

One embodiment is a vehicle control device 1, comprising: a sign recognizer 60 configured to recognize, from an image captured by a camera 13 configured to capture an image of an area around a vehicle 2, a sign part 80 corresponding to a lane reduction sign 50 including one or two bent line parts 51 each including a bent portion 51A and multiple straight line parts 52 each of which is a straight solid line or broken line; and a merging lane identifier 61 configured to acquire, from the sign part 80, one or two first shapes 81A, 83A corresponding to the one or two bent line parts 51 and multiple second shapes 81B, 83B corresponding to the multiple straight line parts 52, and to identify position of the merging lane(s) based on the one or two first shapes and the multiple second shapes.

According to this aspect, a vehicle control device 1 capable of identifying the position of the merging lane(s) from the lane reduction sign 50 with good accuracy can be provided. Since the vehicle control device 1 identifies the position of the merging lane(s) based on characteristic parts of the lane reduction sign 50, it is possible to properly identify the position of the merging lane(s) from various variations of the lane reduction sign 50.

In the above embodiment, the merging lane identifier 61 may comprise: at least one of a first identifier 63 and a second identifier 64; and a decider 65 configured to identify the merging lane(s) based on at least one of an identification result of the first identifier 63 and an identification result of the second identifier 64, wherein the first identifier 63 may comprise: a region discriminator 68 configured to acquire, from the sign part 80, multiple regions 81 corresponding to the one or two bent line parts 51 and the multiple straight line parts 52; and a first post-processor 69 configured to classify the multiple regions 81 acquired by the region discriminator 68 as the one or two first shapes corresponding to the one or two bent line parts 51 and the multiple second shapes corresponding to the multiple straight line parts 52 and to identify the position of the merging lane(s) based on the one or two first shapes and the multiple second shapes, and the second identifier 64 may comprise: a rectangle discriminator 71 configured to acquire, from the sign part 80, multiple bounding boxes 83 respectively surrounding the one or two bent line parts 51 and the multiple straight line parts 52; and a second post-processor 72 configured to classify the multiple bounding boxes 83 acquired by the rectangle discriminator 71 as the one or two first shapes corresponding to the one or two bent line parts 51 and the multiple second shapes corresponding to the multiple straight line parts 52 and to identify the position of the merging lane(s) based on the one or two first shapes and the multiple second shapes.

According to this aspect, since the vehicle control device 1 identifies the position of the merging lane(s) based on characteristic parts of the lane reduction sign 50, it is possible to properly identify the position of the merging lane(s) from various variations of the lane reduction sign 50.

In the above embodiment, the merging lane identifier 61 may comprise a third identifier 66 including a classifier 74 configured to output the position of the merging lane(s) in response to input of the sign part 80, the third identifier 66 being configured to identify the position of the merging lane(s) in response to input of the sign part 80 by using the classifier 74, and the decider 65 may be configured to identify the position of the merging lane(s) based on at least one of the identification result of the first identifier 63 and the identification result of the second identifier 64 and based on an identification result of the third identifier 66.

According to this aspect, since the identification result of the third identifier 66 using the classifier 74 is taken into account, the identification accuracy of the position of the merging lane(s) improves.

In the above embodiment, the merging lane identifier 61 may be configured to identify the position of the merging lane(s) based on the position of the one or two first shapes relative to the multiple second shapes and a position of each second shape, of the multiple second shapes, that has a vertical length less than or equal to a predetermined percentage of a vertical length of the one or two first shapes.

According to this aspect, since the vehicle control device 1 identifies the position of the merging lane(s) based on characteristic parts of the lane reduction sign 50, it is possible to properly identify the position of the merging lane(s) from various variations of the lane reduction sign 50.

In the above embodiment, the vehicle control device 1 may comprise a driving lane determiner 44 configured to determine whether a lane on which the vehicle 2 is traveling is the merging lane based on merging lane information related to the merging lane(s) outputted by the merging lane identifier 61 and a position of the vehicle 2.

According to this aspect, it can be determined whether a lane change of the vehicle 2 is necessary.

In the above embodiment, the vehicle control device 1 may comprise a notifier 45 configured to control a notification device (the display 21, the speaker 22) to notify an occupant in a case where the driving lane determiner 44 determines that the lane on which the vehicle 2 is traveling is the merging lane.

According to this aspect, the vehicle control device 1 can notify the driver of the vehicle 2 that a lane change is necessary by controlling the notification device.

In the above embodiment, the vehicle control device 1 may comprise a driving assister 46 configured to control, in a case where the driving lane determiner 44 determines that the lane on which the vehicle 2 is traveling is the merging lane, a steering device 5 to make the vehicle 2 change lanes to a remaining lane which is different from the merging lane.

According to this aspect, the vehicle control device 1 can make the vehicle 2 change lanes by controlling the steering device 5.

In the above embodiment, the merging lane identifier 61 may be configured to identify the merging lane(s) at a predetermined time interval and to correct a current identification result based on a previous identification result.

According to this aspect, the identification accuracy of the position of the merging lane(s) can be improved.

Another embodiment is a vehicle control method to be executed by a computer, the vehicle control method comprising: recognizing, from an image captured by a camera 13 configured to capture an image of an area around the vehicle 2, a sign part 80 corresponding to a lane reduction sign 50 including one or two bent line parts 51 each including a bent portion 51A and multiple straight line parts 52 each of which is a straight solid line or broken line; and acquiring, from the sign part 80, one or two first shapes 81A, 83A corresponding to the one or two bent line parts 51 and multiple second shapes 81B, 83B corresponding to the multiple straight line parts 52 and identifying position of a merging lane(s) based on the one or two first shapes 81A, 83A and the multiple second shapes 81B, 83B.

According to this aspect, a vehicle control method capable of identifying the position of the merging lane(s) from the lane reduction sign 50 with good accuracy can be provided. Since the vehicle control method identifies the position of the merging lane(s) based on characteristic parts of the lane reduction sign 50, it is possible to properly identify the position of the merging lane(s) from various variations of the lane reduction sign 50.

Another embodiment is a non-transitory computer-readable storage medium storing a control program, wherein the control program, when executed by a computer, causes the computer to execute a vehicle control method comprising: recognizing, from an image captured by a camera 13 configured to capture an image of an area around the vehicle 2, a sign part 80 corresponding to a lane reduction sign 50 including one or two bent line parts 51 each including a bent portion 51A and multiple straight line parts 52 each of which is a straight solid line or broken line; and acquiring, from the sign part 80, one or two first shapes 81A, 83A corresponding to the one or two bent line parts 51 and multiple second shapes 81B, 83B corresponding to the multiple straight line parts 52 and identifying position of a merging lane(s) based on the one or two first shapes 81A, 83A and the multiple second shapes 81B, 83B.

According to this aspect, a non-transitory computer-readable storage medium storing a control program for causing a computer to execute a vehicle control method capable of identifying the position of the merging lane(s) from the lane reduction sign 50 with good accuracy can be provided.

What is claimed is:

1. A vehicle control device, comprising:
a sign recognizer configured to recognize, from an image captured by a camera configured to capture an image of an area around a vehicle, a sign part corresponding to a lane reduction sign including one or two bent line parts each including a bent portion and multiple straight line parts each of which is a straight solid line or broken line; and
a merging lane identifier configured to acquire, from the sign part, one or two first shapes corresponding to the one or two bent line parts and multiple second shapes corresponding to the multiple straight line parts, and to identify position of a merging lane(s) based on the one or two first shapes and the multiple second shapes.

2. The vehicle control device according to claim 1, wherein the merging lane identifier comprises:
at least one of a first identifier and a second identifier; and
a decider configured to identify the merging lane(s) based on at least one of an identification result of the first identifier and an identification result of the second identifier,
wherein the first identifier comprises: a region discriminator configured to acquire, from the sign part, multiple regions corresponding to the one or two bent line parts and the multiple straight line parts; and a first post-processor configured to classify the multiple regions acquired by the region discriminator as the one or two first shapes corresponding to the one or two bent line parts and the multiple second shapes corresponding to the multiple straight line parts and to identify the position of the merging lane(s) based on the one or two first shapes and the multiple second shapes, and
the second identifier comprises: a rectangle discriminator configured to acquire, from the sign part, multiple bounding boxes respectively surrounding the one or two bent line parts and the multiple straight line parts; and a second post-processor configured to classify the multiple bounding boxes acquired by the rectangle discriminator as the one or two first shapes corresponding to the one or two bent line parts and the multiple second shapes corresponding to the multiple straight line parts and to identify the position of the merging lane(s) based on the one or two first shapes and the multiple second shapes.

3. The vehicle control device according to claim 2, wherein the merging lane identifier comprises a third identifier including a classifier configured to output the position of the merging lane(s) in response to input of the sign part, the third identifier being configured to identify the position of the merging lane(s) in response to input of the sign part by using the classifier, and
the decider is configured to identify the position of the merging lane(s) based on at least one of the identification result of the first identifier and the identification result of the second identifier and based on an identification result of the third identifier.

4. The vehicle control device according to claim 1, wherein the merging lane identifier is configured to identify a left end lane as the merging lane in a case where the first shape exists at a left end of the sign part and to identify a right end lane as the merging lane in a case where the first shape exists at a right end of the sign part.

5. The vehicle control device according to claim 4, wherein the merging lane identifier is configured to identify the position of the merging lane(s) based on a position of each second shape, of the multiple second shapes, that has a vertical length less than or equal to a predetermined percentage of a vertical length of the one or two first shapes relative to the one or two first shapes.

6. The vehicle control device according to claim 1, comprising a driving lane determiner configured to determine whether a lane on which the vehicle is traveling is the merging lane based on merging lane information related to the merging lane(s) outputted by the merging lane identifier and a position of the vehicle.

7. The vehicle control device according to claim 6, comprising a notifier configured to control a notification device to notify an occupant in a case where the driving lane determiner determines that the lane on which the vehicle is traveling is the merging lane.

8. The vehicle control device according to claim 6, comprising a driving assister configured to control, in a case where the driving lane determiner determines that the lane on which the vehicle is traveling is the merging lane, a steering device to make the vehicle change lanes to a remaining lane which is different from the merging lane.

9. The vehicle control device according to claim 6, wherein the merging lane identifier is configured to identify the merging lane(s) at a predetermined time interval and to correct a current identification result based on a previous identification result.

10. A vehicle control method to be executed by a computer, the vehicle control method comprising:
recognizing, from an image captured by a camera configured to capture an image of an area around a vehicle, a sign part corresponding to a lane reduction sign including one or two bent line parts each including a bent portion and multiple straight line parts each of which is a straight solid line or broken line; and
acquiring, from the sign part, one or two first shapes corresponding to the one or two bent line parts and multiple second shapes corresponding to the multiple straight line parts and identifying position of a merging lane(s) based on the one or two first shapes and the multiple second shapes.

11. A non-transitory computer-readable storage medium storing a control program, wherein the control program, when executed by a computer, causes the computer to execute a vehicle control method comprising:
recognizing, from an image captured by a camera configured to capture an image of an area around a vehicle, a sign part corresponding to a lane reduction sign including one or two bent line parts each including a bent portion and multiple straight line parts each of which is a straight solid line or broken line; and
acquiring, from the sign part, one or two first shapes corresponding to the one or two bent line parts and multiple second shapes corresponding to the multiple straight line parts and identifying position of a merging lane(s) based on the one or two first shapes and the multiple second shapes.
